(19) United States
(12) Patent Application Publication
(10) Pub. No.: US 2007/0172616 A1
(43) Pub. Date: Jul. 26, 2007

(54) Containment structures and methods

(76) Inventors: Mohammad R. Ehsani, Tucson, AZ (US); Stacey MacDonald, Phoenix, AZ (US); Dennis A. Pauze, Tucson, AZ (US)

Correspondence Address: QUARLES & BRADY LLP, ONE SOUTH CHURCH AVENUE, SUITE 1700, TUCSON, AZ, 85701-1621, US

(21) Appl. No.: 11/340,213

(22) Filed: Jan. 26, 2006

(51) Int. Cl. B60R 21/16

(52) U.S. Cl. 428/36.1

(57) ABSTRACT

An electrolytic cell or other containment structure having a permanent resin and Fiber Reinforced Polymer liner. The liner is permanently adhered to a cleaned and primed surface and contains one or both of woven fabric and chopped fibers.

### BACKGROUND OF THE INVENTION

1. Field of the Invention

This invention relates generally to containment structures, and, more particularly, to containment structures and methods featuring a liner for reinforcing a container, tank, or cell and for protecting against its corrosion and the leakage of its contents.

2. Description of the Related Art

Underground and aboveground storage containers or tanks are widely used for containment of fuels and chemicals. Basic storage tanks for these substances typically are fabricated from steel, reinforced concrete, or glass fiber reinforced plastic, and, depending upon the environment of the installation and the substances being contained, can be subject to corrosion and/or leakage.

In the mining industry, large tanks or containers of acidic solution (so-called “electrolytic cells”) are used in the electrowinning and electrorefining of metals, such as copper, zinc, nickel, cobalt, and manganese. In these processes, electrolytic solutions are pumped through electrodes placed in the cell. An electrical current is passed through the electrodes into solution and purified metal is deposited onto one of the electrodes. Accordingly, these electrolytic cells need to withstand the weight of the electrodes and solution, as well as the temperature of the reaction and the corrosive nature of the electrolyte.

Because leakage of hazardous or otherwise detrimental material often is damaging to the environment and costly and time-consuming to remedy, several systems have evolved to better contain such substances.

Examples of systems include secondary containment devices in association with a primary storage tanks (e.g., apparatus ranging from “double hull” oil transport containers to ponds or moats), container liners, leak detection systems, and the like. One of the more recent developments in this area involves the use of container liners fabricated from elastomers and/or resin-impregnated textiles on primary and secondary containment structures. For example, European Patent Application 1162158 discloses a tank lining method and liner that contains multiple layers of fabrics and resins. Moreover, PCT Application WO86/02883 and U.S. Pat. No. 4,865,899 both disclose retro-fitting containers with a resin and fabric liner.

While certain thermoplastic polyester elastomers can be formulated to be highly impervious to volatile and/or corrosive materials, sheets of such thermoplastics typically do not exhibit sufficient strength and resistance to puncture as is desirable for use as primary or secondary containments. Needless to say, the very nature of the application of primary and secondary containments requires extremely high resistance to puncture and leakage as well as resistance to and protecting against corrosion. This is especially the case for electrolytic cell containments.

Electrolytic cells have evolved from concrete tanks with lead liners, to concrete tanks with plastic or Fiber Reinforced Polymer (FRP) liners draped inside the concrete cells, to, most recently, polymer concrete cells, which resist corrosion better than regular concrete. While most new plants make use of the polymer concrete cells, older plants have delayed discarding the concrete-and-liner cells as long as they continue to operate profitably, albeit with larger maintenance costs. Prior to the adoption of polymer concrete cells by the electrolytic industry, the concrete cells with liners were developed such that only concrete side and end walls were cast. The floor typically was made out of wood, with a liner disposed upon the concrete walls and wood floor. As one might expect, these older cell structures are particularly prone to problems when liner damage occurs.

Damage to the liner and underlying structure can occur in a variety of ways. During operations, the cells are subjected to falling electrodes, misaligned cranes that gauge or cut the sides of the liner when the electrodes are removed, and breakdown over time as the liner ages and becomes cracked and brittle. Once a liner is damaged, electrolyte will leak onto the concrete cell walls and begin to erode the concrete and rebar (the horizontal and vertical steel rods that provide strength to the cement of the cell), eventually compromising the cell's structural integrity.

The wood floors of older cells also see damage as a result of being saturated with solution, which can cause the wood to warp and sag. Since a liner covers the cell structure, leaks can easily go undetected for long periods of time. Once a leak is discovered, the liner, concrete walls, and wood floor must be repaired or replaced. This costs the operation in lost production and in labor and materials used for repair or replacement.

Hence, it is desirable to provide new and improved structures and methods for containment of electrolytes and other chemicals. Moreover, it is desirable to provide new and improved methods for retrofitting existing chemical-containing structures to provide strengthening and to abate existing and minimize future corrosion.

### SUMMARY OF THE INVENTION

The invention relates in general to a containment structure that includes a liner particularly suited for use in association with containers for electrolytic solutions and the like. The liner preferably is substantially continuously bonded to the containment structure (as opposed to being spot bonded or merely draped in or over a structure), which results in an increase in strength of the existing structure as well as a high degree of resistance to corrosion due to the exclusion of oxygen. Moreover, any leakage is kept localized in the event of a liner puncture.

The invention also relates to structures and methods to minimize future, or to abate existing, corrosion by forming a substantially air-tight seal that prevents oxidation. Furthermore, the invention relates to a method for applying or retrofitting FRP systems to containers, including electrolytic cells, so as to better electrically insulate the same. Reduction in corrosion and leaks also reduces damage and maintenance to the floor, as well as concerns over safety and environmental issues relating to solutions being present outside of the containment structure (e.g., slipping, solution leaking to soil, etc.)

In one aspect of the invention, a FRP strengthening system, such as QuakeWrap™ (QuakeWrap, Inc., Tucson, Ariz.), is applied to the walls and optionally the floor of an electrolytic cell. A high-viscosity tack coat of resin material (e.g., QuakeBond™ J200TC) is first applied to the concrete, after which QuakeWrap™ fabric saturated with a resin preferably having a lower viscosity than the tack coat is applied to the cell. Lastly, a resin top-coat is added to the saturated fabric and the liner is allowed to cure.

Preferably, the composition of the top-coat is selected be resistant to the chemical(s) contained with in the cell. In addition, the FRP fabric may include one or more layers of chopped fiber, commonly referred to as mat. The mat serves several functions, including providing a protective layer to prevent damage to the fibers that may occur from the falling of electrodes and providing a smooth finished surface that will prevent formation of pin holes. Other options include using materials with separate layers of mat to provide leak proofing to the system. Preferably, the fabric layer includes fibers oriented at both zero and 90 degrees, thereby reproducing the structure of the horizontal and vertical rebar in reinforcing a concrete cell wall or floor. Single or multiple layers of fabric may be utilized.

Once in place, the FRP strengthening material is allowed to cure either at room temperature or with a heat cure, depending on the electrolytic system. The resin has been designed to withstand standard electrolyte solutions for electrowinning and electrofining with temperatures of up to 80 degrees Celsius. Additionally, the substantially continuous bonding of the FRP material to the tank or cell provides added structural strength and better protects the underlying concrete or wood than a draped or otherwise non-continuously bonded liner because liquid from any breaches is kept localized, i.e., there is no seepage under the liner from the point of a breach to a different location.

In another aspect of the invention, the liner serves as an insulator that will prevent flow of stray current from the cells into beams, columns, footings, and other surrounding structures. Hence, the invention provides a measure of added efficiency and safety.

The apparatus and method of the invention is thought to provide several advantages over existing containment systems. First, the fabric with its fibers aligned in the desired “zero and ninety degrees” directions adds significant strength to the concrete walls of the cell. Next, the fabric and the resin system provide a water-proof barrier that will protect the concrete cell from contact with the electrolyte solution. Furthermore, the continuous and airtight bonding of the liner to the structure minimizes corrosion wrought by oxidation.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 depicts a perspective view of a simplified electrolytic cell of the invention.

FIG. 2 is an enlarged cross-sectional view of the electrolytic cell of FIG. 1 taken along the line 2-2.

FIG. 3 is a magnified view of the liner of the invention.

FIG. 4 is a flow chart depicting in outline the steps of a method of the invention.

### DETAILED DESCRIPTION OF THE PREFERRED EMBODIMENTS

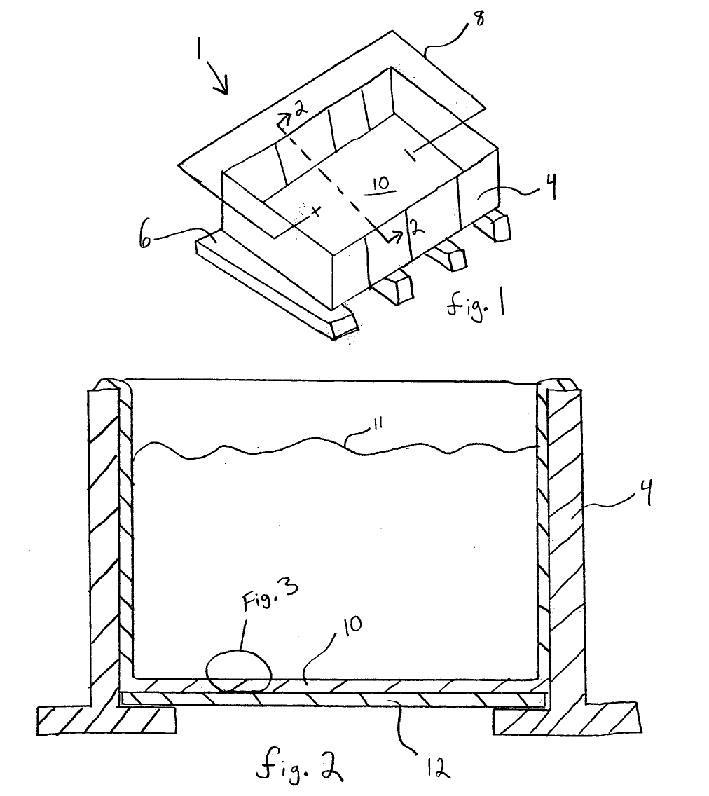

As shown in FIGS. 1-3, the invention generally relates to a container having a permanently and substantially continuously affixed liner. For example, the container may be an electrolytic cell 1. The cell 1 includes a containment structure 4 including a base 6. Preferably, the containment structure and base are composed of concrete or polymer concrete. A means for providing electrical current such that a circuit 8 is formed preferably takes the form of a metal cathode and anode connected to a source of electricity. Permanently bonded upon the interior of the structure 4 is a resin and Fiber Reinforced Polymer (FRP) liner 10 that is at least partially contacted by liquid 11.

As seen in the cross-sectional view of FIG. 2, the liner 10 is bonded at every point in a substantially continuous manner so that any breach is completely localized to the damaged site. Such localized containment of any breach of the liner is extremely important in the electrolytic cell industry because the containment structure 4 of many older cells includes a wooden flooring 12 upon which the liner 10 of the invention may be affixed. Because wood warps and sags in response to prolonged exposure to liquids, the substantially continuous seal of the liner 10 to the wood flooring 12 is an especially desirable feature of the invention in that the possibility of widespread or migrating damage to areas below wall breaches is minimized. Of course, depending upon the situation, a polymer concrete floor may be installed to replace any wood. Accordingly, the installation of the invention on a wood floor is only one example of how the invention may be employed.

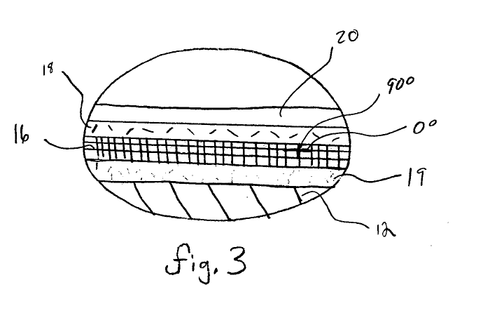

As seen in the magnified section view of FIG. 3, the FRP liner preferably includes a woven fabric 16 and a chopped fiber mat 18. The woven fabric 16 is the lower surface (closest to the floor 12 of the containment structure 4), while the chopped fiber mat 18 is on the upper surface. Even more preferably, the FRP liner 10 includes a woven fabric layer having fibers with an orientation of zero and ninety degrees relative to one another as shown to reproduce the reinforcing structure of the crossed rebar commonly found in concrete cells.

The woven fabric and the chopped fiber mat are preferably integrally formed and may include one or more materials, of which glass, carbon, graphite, and synthetic high strength materials (such as Kevlar®) are especially preferred. The chopped fiber mat 18 serves two specific functions: it protects the woven fabric from damage (e.g., by falling electrode plates, etc.) and it provides a smooth surface that helps to ensure a pinhole free surface.

Preferably, the fabric and chopped fibers are continuously adhered to the floor 12 with a tack coat 19. Also preferably, the resin tack coat 19 is a high-viscosity tack material (e.g., QuakeBond™ J201TC). To provide an extra measure of protection, one or more resin top coat layers, such as top coat 20, preferably are applied to the saturated fabric and chopped fiber liner.

Thus, the combination of the fabrics and resins plus results in a structure that is highly resistant to chemicals (particularly acids) at relatively high operating temperatures, especially when the resin top coat 20 is heat cured.

Preferred resins for use with the invention include resins that provide a combination of high strength, toughness and ductility so that they can effectively transfer the forces from the woven fabric to the substrate (e.g., a cell). Exemplary resins include vinyl esters, polyesters, and two-component epoxies. In addition to the above characteristics, the high viscosity of the tack coat allows the woven fabric and mat that are saturated with the saturating resin to be affixed to the vertical surface of the cell walls without slipping down. Both the tack coat and the saturating resin are also specially designed to resist the relatively high operating temperatures of the acids that are stored in the cell and are highly resistant to chemicals that are stored in the cell. While the overall features of the system remain unchanged, it is envisioned that the resins will be modified for different applications depending on the type, concentration level and the temperature of the chemical that is to be used in the cell.

In the electrolytic cell context, the FRP liner preferably includes an electrically insulating material, such as ceramic-containing woven fabrics and chopped fibers (mat) that are saturated with resin. When properly cured in the field, this combination of materials will result in a “plastic-like” material that will not be conductive of electrical currents.

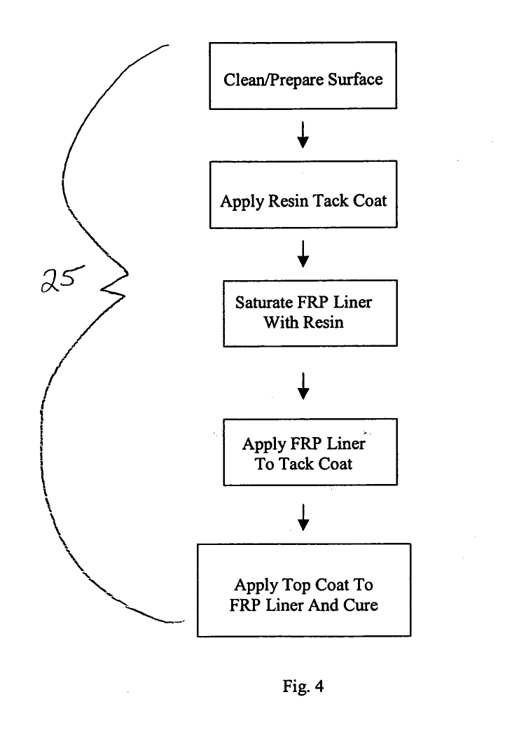

Turning to FIG. 4, a preferred method of the invention is outlined in a flow chart. The method 25 for strengthening a container for liquids includes preparing the surface of the container to be strengthened through, for example, cleaning and priming; providing and applying a tack coat resin onto the surface of the container to be strengthened; saturating the woven fabric and the chopped fiber (mat) with a saturating resin and applying this liner such that the liner is in substantially continuous contacting relationship with the tack resin; applying a resin to coat to the woven fabric and chopped fiber; and allowing the top-coat resin and FRP liner to cure.

Preferably, the top coat includes epoxy resins that are heat cured. Heat curing of the resin is an important feature which enables the system to withstand temperatures as high as 80 C. While there may be other resins in the future that could resist such temperatures even if the resins were cured at ambient temperature, such resins are not known to be available now. The curing may be achieved by covering the cells with a blanket and heating it with an electrical or gas burning heater, or by other means, such as light radiation, etc.

To further illustrate the invention, the following non-limiting example is provided.

A damaged electrolytic cell containing an acidic copper sulfate solution is drained. The interior surface of the cell is inspected for structural damage/corrosion, and any necessary repairs are made prior to surface preparation. The surface preparation may include descaling, power washing, drying, and any other treatment needed under the circumstances to prepare the surface for liner bonding.

A high viscosity tack coat, such as QuakeBond™ J200TC, is then applied with a trowel on the walls of the cell to a thickness of about 40 millimeters. The tack coat is high viscosity in the sense that it should stay in place on the walls without appreciable running or dripping. A fabric liner, such as QuakeWrap™ VB2610, is then cut to size (typically in two to eight foot wide strips that are long enough to cover a section of wall and overlap the floor by six to twelve inches) and laid in a tray that is filled with (or contains) a vinylester, polyester, or epoxy resin, such as QuakeBond™ J301 SR, in order to saturate the fabric. The fabric preferably contains a bottom surface of fibers crossed at zero and ninety degree angles and a top layer that includes a chopped fiber mat. Thus, the saturated fabric is placed on the tack-coated walls with the top surface (mat side) up and the bottom surface in contact with the underlying tack coat and cell structure.

Each successive layer of fabric is placed such that it overlaps the previous layer by six to twelve inches, resulting in a continuous liner when the processed is finished. After air bubbles are removed with a roller, the process above is then repeated for the floor of the cell if necessary (depending on the condition of the floor).

Next, a top coat of resin is applied to the walls and floor with a sprayer to a thickness of 5-10 millimeters. Preferably, the top coat is a two-component epoxy resin, such as QuakeBond™ J401HCR, that is composed of components that will be resistant to the anticipated chemical content of the cell. Also preferably, the top coat is applied when the resin-saturated fabric is still tacky. Otherwise, the surface of the fabric may be roughened to provide a better bonding surface for the top coat.

Finally, the top coat is heat cured at a temperature of 140-150 degrees Fahrenheit for two to three hours. For this step, a torch and blanket may be used to attain and hold the desired curing temperature within the desired range.

Various changes in the details and components that have been described may be made by those skilled in the art within the principles and scope of the invention herein described in the specification and defined in the appended claims. For instance, the invention can be utilized in conjunction with new or previously damaged containers or cells. Moreover, the resins of the invention are not limited to a particular mode of application such that they may, for example, be applied with rollers, brushes, spraying equipment, or a “roll-through” fabric-saturating machine when appropriate to the application at hand. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

What is claimed is:

1. An apparatus, comprising:
a containment structure housing a liquid; and
a resin and Fiber Reinforced Polymer (FRP) liner permanently adhered to an interior of said containment structure and at least partially contacted by said liquid.

2. The apparatus of claim 1, wherein said resin and FRP liner comprises a woven fabric and a chopped fiber, wherein said chopped fiber forms a mat layer that is at least partially contacted by said liquid.

3. The apparatus of claim 1, wherein said resin and FRP liner comprises a woven fabric containing fibers that are oriented substantially at zero and ninety degrees relative to each other.

4. The apparatus of claim 2, wherein said woven fabric contains fibers that are oriented substantially at zero and ninety degrees relative to each other.

5. The apparatus of claim 2, wherein said woven fabric and said chopped fiber is selected from the group consisting of one or more of glass, carbon, graphite, and synthetic high strength materials.

6. The apparatus of claim 2, wherein a resin top coat is disposed atop said chopped fiber and cured thereto.

7. The apparatus of claim 1, wherein said resin is selected from the group consisting of vinylesters, polyesters, and two-component epoxies.

8. The apparatus of claim 1, wherein said resin and FRP liner further comprises an electrically insulating material.

9. The apparatus of claim 1, wherein said resin and FRP liner is permanently adhered to an interior of said containment structure such that said liner is continuously bonded to said surface in substantially air-tight arrangement therewith.

10. An electrolytic cell, comprising:
an containment structure housing a liquid;
means for providing an electrical current within said containment structure; and
a resin and Fiber Reinforced Polymer (FRP) liner permanently adhered to an interior of said containment structure and at least partially contacted by said liquid.

11. The cell of claim 10, wherein said containment structure comprises a concrete or polymer concrete tank.

12. The cell of claim 10, wherein said resin and FRP liner comprises a woven fabric and a chopped fiber, wherein said chopped fiber forms a mat layer that is at least partially contacted by said liquid.

13. The cell of claim 10, wherein said resin and FRP liner comprises a woven fabric containing fibers that are oriented substantially at zero and ninety degrees relative to each other.

14. The cell of claim 12, wherein said woven fabric contains fibers that are oriented substantially at zero and ninety degrees relative to each other.

15. The cell of claim 12, wherein said woven fabric and said chopped fiber is selected from the group consisting of one or more of glass, carbon, graphite, and synthetic high strength materials.

16. The cell of claim 12, wherein a resin top coat is disposed atop said chopped fiber and cured thereto.

17. The cell of claim 10, wherein said resin is selected from the group consisting of vinylesters, polyesters, and two-component epoxies.

18. The cell of claim 10, wherein said resin and FRP liner further comprises an electrically insulating material.

19. The cell of claim 10, wherein said resin and FRP liner is permanently adhered to an interior of said containment structure such that said liner is continuously bonded to said surface in substantially air-tight arrangement therewith.

20. A method for strengthening, and minimizing corrosion of, a container for liquids, comprising the steps of:
(a) preparing the interior surface of the container to receive a resin;
(b) applying a tack coat resin upon said interior surface;
(c) applying a resin-saturated FRP liner such that the liner is in substantially flush contacting relationship with said tack coat resin, wherein said FRP liner is permanently adhered to an interior of said containment structure such that said liner is continuously bonded to said surface in substantially air-tight arrangement therewith.

21. The method of claim 20, further including the step of applying a resin top coat to said FRP liner.

22. The method of claim 21, further including the step of heat curing said resin top coat.

23. The method of claim 20, further including the step of retrofitting an existing container by carrying out steps (a)-(c) on top of an existing liner.

24. The method of claim 21, where said step of applying a resin top coat includes providing a two-component epoxy.

25. The method of claim 21, wherein said step of applying the resin top coat further includes selecting the top coat based on its chemical resistance to a liquid held within said container.

26. The method of claim 20, wherein step (c) includes providing a resin and FRP liner comprising a woven fabric and a chopped fiber.

27. The method of claim 20, wherein step (c) includes providing a resin and FRP liner containing a woven fabric and a chopped fiber mat upper surface, with the woven fiber being placed in contact with said container interior such that said mat is at least partially contacted with a contained liquid.

28. The method of claim 20, wherein step (c) includes providing a resin and FRP liner containing a woven fabric having fibers that are oriented substantially at zero and ninety degrees relative to each other.

29. The method of claim 20, wherein step (c) includes providing a resin and FRP liner having an electrically insulating material contained therein.

30. The method of claim 20, wherein said tack coat resin of step (b) is of a higher viscosity than said resin of step (c).
